(19) United States
(12) Patent Application Publication
(10) Pub. No.: US 2012/0097303 A1
(43) Pub. Date: Apr. 26, 2012

(54) METHOD AND CONSTRUCTION FOR IMPROVED SNOW TRACTION, HIGHWAY WEAR, AND OFF-ROAD PERFORMANCE OF A TIRE

(76) Inventor: Fang Zhu, Greer, SC (US)

(21) Appl. No.: 13/378,413

(22) PCT Filed: Jun. 28, 2010
(86) PCT No.: PCT/US10/40172

§ 371 Date: Dec. 15, 2011

Related U.S. Application Data
(60) Provisional application No. 61/221,184, filed on Jun. 29, 2009.

(51) Int. Cl. B60C 11/12; B29D 30/00

(52) U.S. Cl. 152/209.18; 29/894.37

(57) ABSTRACT

A method of improving the snow traction and off-road performances of a tire and tire constructed according to such method are provided. More specifically, a method is provided for constructing the tread of a tire into inner and outer portions by extending a connecting sipe from the free edge of a tread feature that, connects to an inner sipe that surrounds a boss or projection within the tread feature. In some eases, this geometry is further optimized by designing She inner and outer portions of the other performance features. The present invention further relates to a tire having such tread constructions.

### FIELD OF THE INVENTION

The present invention relates to method of improving the snow traction performance of a tire and relates to a tire constructed according to such method. More specifically, the present invention relates to a method of constructing the tread of a tire into inner and outer portions by extending a connecting sipe from the free edge of a tread feature that connects to an inner sipe that surrounds a boss or projection within the tread feature. In some cases, this geometry is further optimized by designing the inner and outer portions of the tread feature so that they experience different radial deformations under operating conditions so as to improve snow traction and other performance features. The present invention further relates to a tire having such tread constructions.

### BACKGROUND OF THE INVENTION

The performance of a tire in snow conditions is determined primarily by the amount of biting edge on the tread and the identity of the tread material. For purposes of explanation, consider tread block 100 in FIG. 1A, where x represents the direction of travel and y represents a direction perpendicular thereto (i.e., the axial direction). If the contribution of the tread material to traction is discounted, the snow traction along the x direction of a tire having tread block 100 depends upon the biting edges 105 and 110 of tread block 100. To improve snow traction without changing the tread compound, more edges such as 105 and 110 are needed. Accordingly, as shown in FIG. 1B, sipe 115 is introduced into tread block 100. However, the addition of sipe 115 has the undesirable effect of decreasing the rigidity of tread block 100 along the x direction, which will result in degrading the highway performance of the tire.

A compromise between the tread blocks of FIGS. 1A and 1B is shown in FIG. 1C. Here, tread block 100 includes a partial sipe 120 that extends only partly across the tread block 100 in the y-direction. The tread block of FIG. 1C will provide higher rigidity than the tread block of FIG. 1B but with less snow traction due to the reduced amount of biting edges. Therefore, the tread block of FIG. 1C will exhibit highway wear and snow traction performance that is between the performance of the tread blocks shown in FIGS. 1A and 1B. However, in off-road applications, a tire tread can experience tearing due to the interaction with gravel and stones. In such situations, sipe 120 may experience stress concentrations at terminal portion 125, which can generate undesired cracks in tread block 100. As a result, part of tread feature 100 may be torn off after a period of usage in such off-road conditions.

Accordingly, a tire having improved snow traction performance without an undesirable decrease in highway performance would be useful. A tire that also provides improved snow traction and suitable performance in off-road applications would also be useful.

### SUMMARY OF THE INVENTION

Objects and advantages of the invention will be set forth in part in the following description, or may be obvious from the description, or may be learned through practice of the invention. In one exemplary aspect of the invention, a method is provided for improving the traction and off-road performances of a tire, the tire defining radial and axial directions. The method includes the steps of providing a tread feature having an inner portion, an outer portion and a free edge, wherein the inner portion and outer portion are created by defining an inner sipe that surrounds the inner portion and a connecting sipe that extends to the inner sipe from the free edge of the tread feature.

The method may also include the following steps such as applying an operating load to the tread feature; determining the difference in radial deformation along the radial direction of the inner portion relative to the outer portion under the operating load; modifying the construction of the inner portion, outer portion, or both of the tread feature if the difference in radial deformation between the inner portion and the outer portion is not equal to, or greater than, 0.1 mm; and repeating one or more of the steps of applying, determining, and modifying until the difference in radial deformation between the inner portion and the outer portion during an operating load is equal to, or greater than, 0.1 mm.

This exemplary method may include other steps or modifications. For example, the method may also include the steps of operating the tire while repeatedly subjecting the outer portion of the tread feature to a radial deformation that is at least 0.1 mm or greater than the radial deformation of the inner portion of the tread feature. Alternatively, the method may also include the steps of operating the tire while repeatedly subjecting the inner portion of the tread feature to a radial deformation that is at least 0.1 mm or greater than the radial deformation of the outer portion of the tread feature. The defining sipe may have a tubular shape of predetermined radius, and the tubular shape can have a length that extends along the radial direction of the tire.

The method may include the step of providing a connecting sipe that extends through the outer portion from a single, exterior edge of the tread feature and connects to the defining sipe. The connecting sipe may extend along the axial direction of the tire. For some exemplary embodiments, the predetermined radius of the defining sipe may be greater than or equal to about 1.5 mm and/or the defining sipe may have a width of about 0.2 mm. The defining sipe may include undulations along the radial direction of the tire. The tire may be constructed so that the distance between any exterior edge of the tread feature and the defining sipe is greater than or equal to about 3 mm.

According to this exemplary method of the present invention, the providing step may include a simulated tread feature, and the applying step may include simulating the application of an operating load to the tread feature. The determining step, for example, may include the application of finite element analysis to the simulated tread feature from the providing step. The step of modifying the construction may include changing the physical dimensions of the inner portion, outer portion, or both of the tread feature. Alternatively, or in addition thereto, the step of modifying the construction may include changing the physical properties of the inner portion, outer portion, or both of the tread feature. Alternatively, or in addition thereto, the step of modifying the construction may include changing the composition of the material used for the inner portion, outer portion, or both of the tread feature.

In another exemplary aspect, the present invention provides for a tire having improved traction and off-road performances, the tire defining axial and radial directions. This exemplary embodiment of the tire includes at least one tread feature, the tread feature having an inner portion, an outer portion and a free edge, wherein said inner and outer portions are created by defining an inner sipe that surrounds the inner portion and a connecting sipe that extends to the inner sipe from the free edge of the tread feature, forming an angle with the free edge of the tread feature.

The inner portion and outer portions may be constructed so that the difference in radial deformation of the inner and outer portions when the tire is subjected to an operating load is greater than, or equal to, about 0.1 mm. The defining sipe may include a tube defined by the inner and outer portions of the tread feature with the tube having a width of no less than about 0.2 mm, and the tube having a predetermined radius of no less than about 1.5 mm. The inner sipe and connecting sipe may include undulations along the radial direction of the tire. Also, the connecting sipe may undulate in a direction that is substantially perpendicular to the radial direction of the tire. In some cases, the angle the connecting sipe forms with the free edge of the tread feature is ninety degrees.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIGS. 1A-1C are schematics of tread blocks, illustrating differences in biting edges.

FIG. 2A is a schematic of an exemplary embodiment of a tread feature—specifically, a tread block—constructed according to the present invention showing a connecting sipe that is undulating in a direction that is substantially perpendicular to the radial direction of the tire.

FIG. 2B is a schematic of an exemplary embodiment of a tread feature—specifically, a tread block—constructed according to the present invention showing a connecting sipe that forms an angle with the free edge of the tread feature that is not perpendicular thereto and an inner sipe that has an arbitrary perimeter.

FIG. 2C is a schematic of an exemplary embodiment of a tread feature—specifically, a tread block—constructed according to the present invention showing a connecting sipe that forms an angle with the free edge of the tread feature that is perpendicular thereto and an inner sipe that has tubular shape.

FIGS. 3A and 3B are schematic, side views of an exemplary embodiment of a tread block constructed according to the present invention taken along lines 3A-3A and 3B-3B of FIG. 2A.

FIG. 4 is a perspective view of a simulated tread block for description of exemplary methods of the present invention.

FIGS. 5, 6, and 7 are plots of data for purposes of illustrating aspects of the present invention.

FIGS. 8 and 9 are treads that were compared for purposes of testing aspects of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

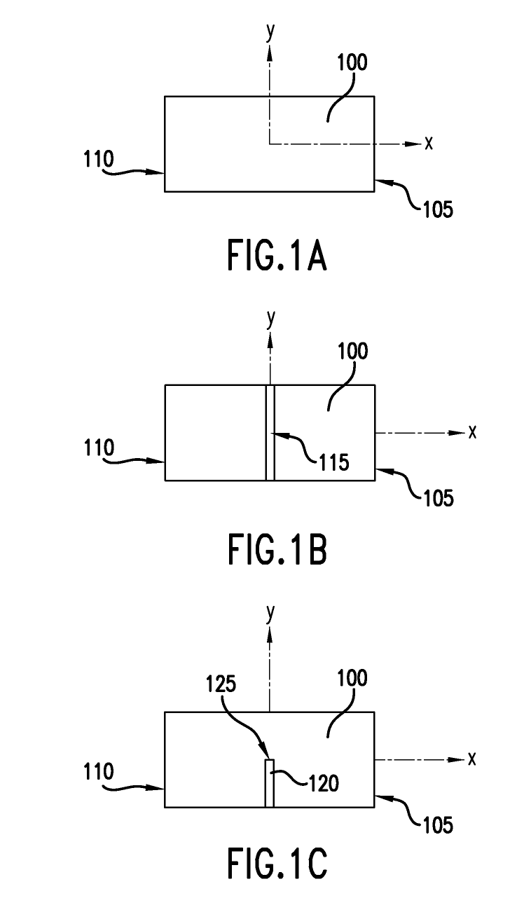

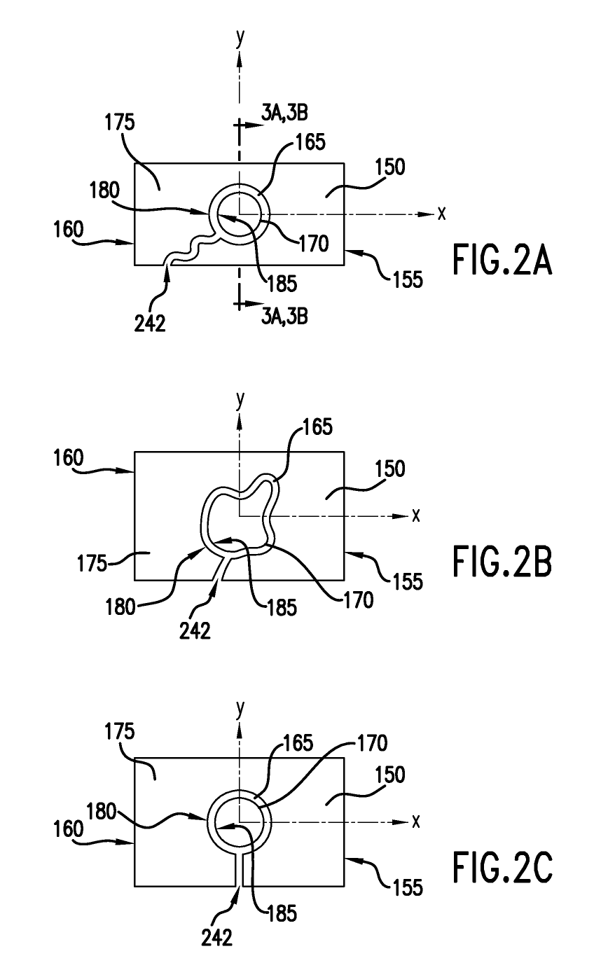

FIG. 2A illustrates an exemplary embodiment of a tread feature i.e., a tread block 150 constructed according to the invention. Tread block 150 includes biting edges 155 and 160. In addition thereto, tread block 150 includes a defining or inner sipe 165—i.e., a sipe 165 that defines tread block 150 into an inner portion 170 and an outer portion 175. As such, sipe 165 creates additional biting edges created by the surfaces 180 and 185 and thereby improves snow traction. Additional biting edges are provided by connecting sipe 242 to improve snow traction. As shown, the connecting sipe 242 is wavy or undulating to provide additional tread block stiffness in the general direction in which the sipe 242 extends. When compared to the tread block 100 of FIG. 1B, tread block 150 has increased tread block rigidity and, therefore, improved highway wear performance because of sipe 165 and undulating connecting sipe 242. Compared to the tread block 100 of FIG. 1C, tread block 150 decreases stress concentrations and, consequently, decreases the likelihood of tread tearing in off-road conditions such as gravel. Also, the extra biting edges provided by sipe 242 is an improvement over the tread block 100 of FIG. 1C, helping the tread block 150 of FIG. 2A match the snow traction of the tread block 100 of FIG. 1B.

Similarly, FIG. 2B shows a similar tread block 150 where the connecting sipe 242 is relatively straight and forms an angle with the free edge of the tread block 150. In this case, the angle is not ninety degrees and it is contemplated that the connecting sipe can extend from any free edge that has any orientation and form any desired angle therewith. Also, the general direction that the sipe extends may be anything that is desired including axial, circumferential or any other direction of the tire. Looking at inner or defining sipe 165, it forms an arbitrary perimeter that surrounds a complimentary shaped inner portion 170. It is also contemplated that the perimeter could be polygonal as well. Thus, this embodiment shows that the inner or defining sipe can have any shape as long as inner and outer portions of the tread feature are created.

Further improvement to tread block 150 can also be achieved by the addition of a linear sipe 242 as shown in FIG. 2C. The addition of linear sipe 242 can result in improvement to tread noise by providing an exit channel through which air may vent that would otherwise be trapped in sipe 165. Linear sipe 242 will also further improve snow traction by providing additional biting edges. As has been shown, the orientation and path of any connecting sipe may be altered in virtually any manner that is desired. Also, a plurality of inner or defining sipes can be used within a tread feature, each may have one or more connecting sipes extending from them. It is also contemplated that geometry of a connecting sipe and/or inner sipe may vary by having other features such as undulations. Likewise, the thickness of the sipes can be within typical ranges used in industry, such as 0.1 mm and larger. A construction that provides the required difference in radial deformation between the inner and outer portions 170 and 175 can be determined by the inventive methods as will be described hereafter.

The inventors have discovered that the snow traction performance of a tire utilizing tread block 150 can be dramatically improved without compromising highway and off-road performance. As will be more fully described herein, such improved performance is achieved by carefully designing a tread feature such as tread block 150 so that under operating loads the inner and outer portions 170 and 175 will deform by different amounts along the radial direction. More specifically, the inventors have determined that improved snow traction is achieved by constructing the inner and outer portions 170 and 175 so that a difference in radial deformation between such portions of at least about 0.1 mm occurs during operation. The inventors have also discovered methods of constructing such a tread feature so as to ensure that at least 0.1 mm difference in radial deformation occurs during operation.

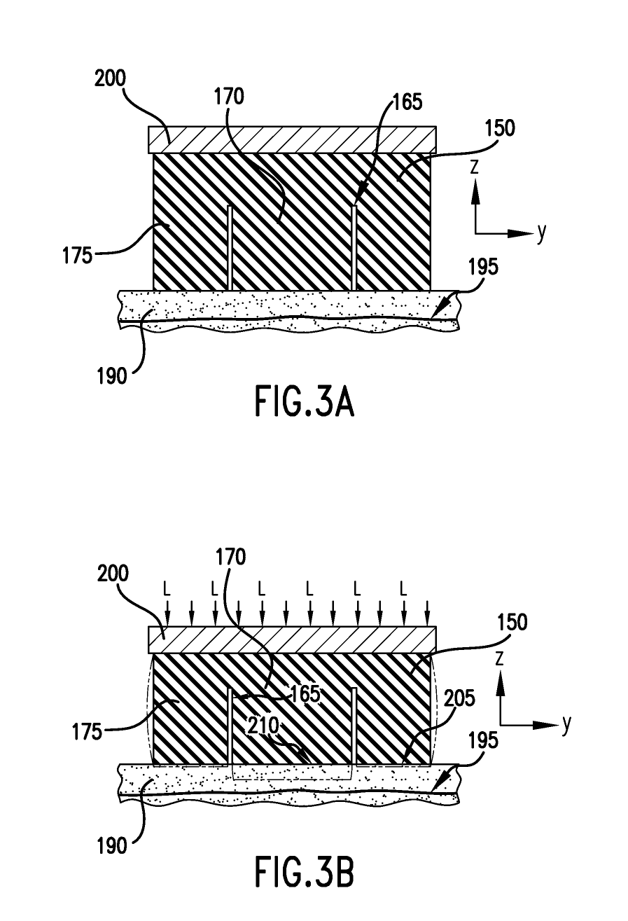

FIG. 3A is a cross-sectional view of tread block 150 taken along the y-axis i.e., the transverse direction. Tread block 150 is connected to belt 200 at one side and contacts snow 190 on the traveling surface 195. Sipe 165 separates tread block 150 into outer portion 175 and inner portion 170. In FIG. 3A, tread feature 150 is shown without any load applied.

FIG. 3B shows tread block 150 under an operating load as represented by arrows L. In this state, load L pushes the belt 200 downward while compressed snow 190 exerts an equal and opposite force upward against the contact surfaces 205 and 210 of the outer and inner portions 175 and 170. By properly sizing such portions of tread block 150, the outer portion 175 will experience a different amount of radial deformation (i.e., deformation along the z-axis) than the inner portion 170. For purposes of illustration), this difference in deformation has been exaggerated in FIG. 3B and is shown in phantom lines. The inventors have determined that the inner and outer portions 170 and 175 should be constructed so that a difference in deformation of a least about 0.1 mm occurs during operation in order to improve traction performance.

As shown in FIG. 3B, outer portion 175 is deforming more along the radial direction than the inner portion 170. In such case, the inner portion 170 operates as a stud to penetrate into the snow 190 and provide more traction. Tread block 150 can also be designed so that the inner portion 170 will deform more than the outer portion 175 so as to create a depression at surface 210. In this construction, when the tread block 150 leaves the ground as the tire rotates, if properly sized, the inner portion 170 will operate as a cleaner—i.e., ejecting the snow packed into the sipe 165 and the depression at surface 210.

Again, tread block 150 should be constructed so that a difference in radial deformation of at least about 0.1 mm occurs during operation. As stated, the required difference in radial deformation can be achieved through careful design of the size of sipe 165, inner portion 170 and outer portion 175 of tread block 150. By way of example and further description of the invention, a process of designing tread block 150 through simulations with finite element analysis will now be described. Using the teachings disclosed herein, one of skill in the art will understand that the present invention applies not only to tread blocks but to other tread features as well such as e.g., tread ribs. Also, this phenomenon applies equally to tread features that have and do not have connecting sipes.

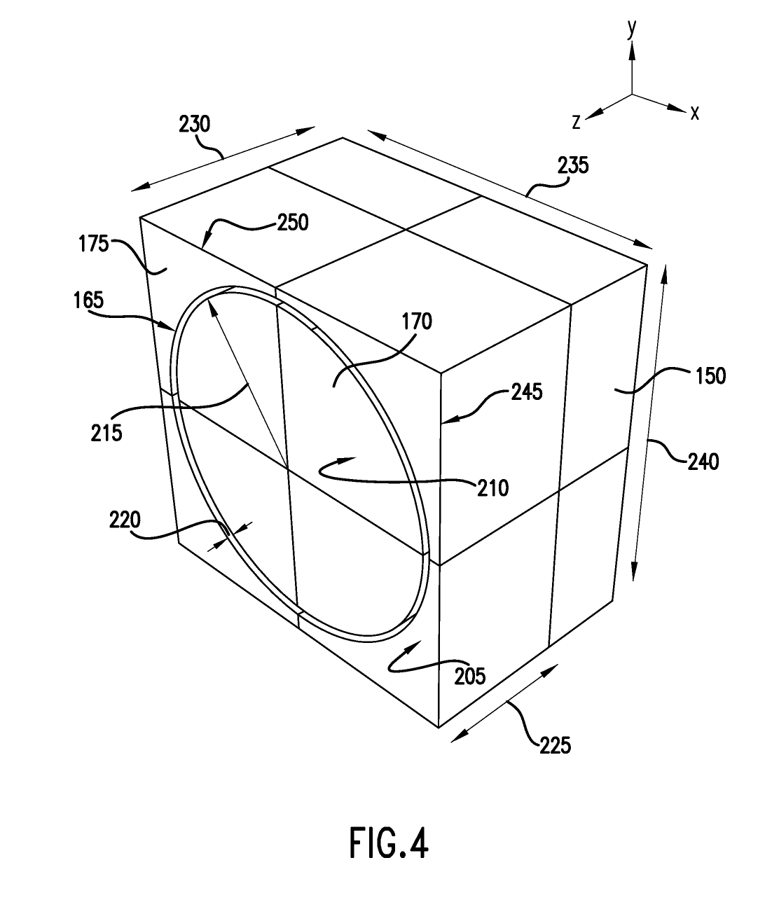

FIG. 4 shows a three-dimensional view of a simulated model for tread block 150 for use with finite element analysis. Inner portion 170 has a radius 215. Sipe 165 is defined by sipe width 220 and sipe depth 225. Tread block 150 has a depth 230 along the radial or z direction, a width 235 along the direction of travel or x direction (sometimes referred to as the circumferential direction of the tire), and a transverse width 240 along the axial or y direction.

Sipe 165 is tubular in shape as shown in FIG. 4. However, other shapes for sipe 165 can be used. By way of example, sipe 165 could be shaped as a star, cross, circle, ellipse, and other shapes as well. In addition, the shape of sipe 165 along the radial or z-direction can also be varied between straight, curved, and undulating walls such that the three-dimensional construction of sipe 165 creates a cone, cylinder, baffles, and various other shapes.

In order to simulate conditions of operation, a nominal pressure of five 0.05 daN/mm² (5 bar) was applied to the tread surface (surfaces 205 and 210) of tread block 150, and the tread block was restrained from any displacement along the surface connecting with belt 200 (see FIGS. 3A and 3B). A modulus for the tread block rubber of 5.47 MPa at 10 percent strain was selected. In addition, tread block 150 was simulated having widths 235 and 240 of 28 mm in both the x and y directions, a sipe width 220 of 0.4 mm, a sipe depth 225 of 8 mm, and a tread block depth 230 of 13 mm. Using finite element analysis, the radial deformation of the inner and outer portions 170 and 175 with various sipe radii 215 was determined and the results are shown in Table 1. Table 1.

TABLE 1
Displacement of tread block surface with different sipe radius

| | | Inner | Outer | |
|---|---|---|---|---|
| Sipe | Radius | sub-block | sub-block | Inner − Outer |
| Radius | Divided by | displacement | Displacement | Difference |
| (mm) | Block width | (mm) | (mm) | (mm) |
| 10 | 0.36 | −0.47 | −0.83 | 0.36 |
| 8 | 0.29 | −0.53 | −0.71 | 0.18 |
| 6 | 0.21 | −0.55 | −0.64 | 0.09 |
| 4 | 0.14 | −0.58 | −0.58 | 0.00 |
| 2 | 0.07 | −0.64 | −0.53 | −0.11 |

(Block depth = 13 mm, Block width = 28 mm, Sipe gap = 0.2 mm, Sipe depth = 8 mm, Modulus = 5.47 MPa)

As indicated by Table 1, as the sipe radius 215 increases, deformation of the outer portion 175 for a given load also increases while the deformation of the inner portion 170 decreases. However, in a manner unexpected, note also that the difference in radial deformation between the inner and outer portions 170 and 175 decreases and then increases as the sipe radius 215 increases. As a result, for the tread block simulated in Table 1, sipe radii between 4 mm and 6 mm do not provide a sufficient difference in radial deformation (at least about 0.1 mm) to appreciably improve snow traction. Accordingly, the inventors also discovered that not every tread feature having inner and outer portions will experience radial deformations that improve snow traction and, instead, must be specifically designed as described herein to experience the desired amount of radial deformation—i.e., at least about 0.1 mm.

The results of Table 1 also indicate that for this particular configuration of tread block 150, when the sipe radius 215 is less than or equal to 2 mm, the inner portion 170 deforms more along the radial or z-direction than the outer portion 175 and, therefore, operates as a cleaner. When the sipe radius 215 is greater than or equal to 6 mm, the inner portion 170 deforms less along the radial or z direction than the outer portion 175 and, therefore, operates as a stud.

As used herein, about 0.1 mm deformation difference between the inner and outer tread blocks 170 and 175 is used to define a cleaner or a stud. More specifically, a stud is created by tread block 150 when the outer portion 175 deforms 0.1 mm more along the radial direction than the inside portion 170, and a cleaner is created when the inner portion 170 deforms 0.1 mm more along the radial direction than the outside portion 175. Increasing the deformation difference between the inside and outside portions 170 and 175 results in improvement in snow traction.

For off-road performance, stress concentrations should be minimized to decrease tearing. As such, generally the sipe radius 215 should not be less than about 1.5 mm and the distance between sipe 165 and outer edges, such as 245 and 250, should be greater than 3 mm. Therefore, for a head block similar to that in FIG. 4 with dimensions as used in Table 1, sipe radius 215 should fall in one of the following two ranges:
Range 1: 1.5 mm≦sipe radius 215≦2 mm
Range 2: 6 mm≦sipe radius 215≦9.5 mm

As compared to the design shown in FIG. 1B, both of these ranges will deliver improved snow traction without compromising off-road tearing or highway wear. However, Range 2 will provide better snow traction because this range will provide a larger amount of biting edge. However, the highway wear of Range 2 may not perform as well as Range 1 because the rigidity of the tread block 150 resulting from Range 2 will be less than that of Range 1. Accordingly, Range 1 and Range 2 offer selections for different applications with Range 2 being more appropriately suited for a tire intended for more snow or winter use.

The depth 225 of sipe 165 is also an important parameter influencing the design of sipe radius 215. Table 2 presents the simulation results for a sipe depth 225 of 11 mm with all other parameters the same as those used in the simulation of Table 1.

TABLE 2
Displacement of tread block surface with different sipe radii

| | | Inner | Outer | |
|---|---|---|---|---|
| Sipe | Radius | sub-block | sub-block | Inner − Outer |
| Radius | Divided by | displacement | Displacement | Difference |
| (mm) | Block width | (mm) | (mm) | (mm) |
| 10 | 0.36 | −0.53 | −0.77 | 0.25 |
| 8 | 0.29 | −0.58 | −0.70 | 0.12 |
| 6 | 0.21 | −0.61 | −0.64 | 0.03 |
| 4 | 0.14 | −0.65 | −0.57 | −0.08 |
| 2 | 0.07 | −0.71 | −0.51 | −0.21 |

(Block depth = 13 mm, Block width = 28 mm, Sipe gap = 0.2 mm, Sipe depth = 11 mm, Modulus = 5.47 MPa)

As compared to Table 1, the deformation of the outer portion 175 still increased with an increase in sipe radius 215 while the deformation of inner portion 170 decreased. However, in a manner that was unexpected, the difference in radial deformation between the inner and outer portion as a function of sipe radius 215 for the tread block of Table 2 is different than the tread block of Table 1, FIG. 5, for example, shows that the increased sipe depth 225 changes the rate at which increases in sipe radius 215 affect the difference in radial deformation between the inner and outer portions 170 and 175.

Using the design guidelines previously stated, Table 2 and FIG. 5 show that for a sipe with a depth of 11 mm, the design of sipe radius 215 should follow one of the following two ranges:
Range 1: 1.5 mm≦sipe radius 215≦3.5 mm
Range 2: 7.5 mm≦sipe radius 215≦9.5 mm

For the examples of Tables 1 and 2, a sipe width 220 of 0.2 mm was simulated. Table 3 presents the results when a sipe width 220 of 0.4 mm was simulated.

TABLE 3
Displacement of tread block surface with different sipe radius

| | | Inner | Outer | |
|---|---|---|---|---|
| Sipe | Radius | sub-block | sub-block | Inner − Outer |
| Radius | Divided by | displacement | Displacement | Difference |
| (mm) | Block width | (mm) | (mm) | (mm) |
| 10 | 0.36 | −0.45 | −0.88 | 0.43 |
| 8 | 0.29 | −0.48 | −0.77 | 0.29 |
| 6 | 0.21 | −0.52 | −0.67 | 0.15 |
| 4 | 0.14 | −0.57 | −0.59 | 0.02 |
| 2 | 0.07 | −0.64 | −0.53 | −0.11 |

(Block depth = 13 mm, Block width = 28 mm, Sipe gap = 0.4 mm, Sipe depth = 8 mm, Modulus = 5.47 MPa)

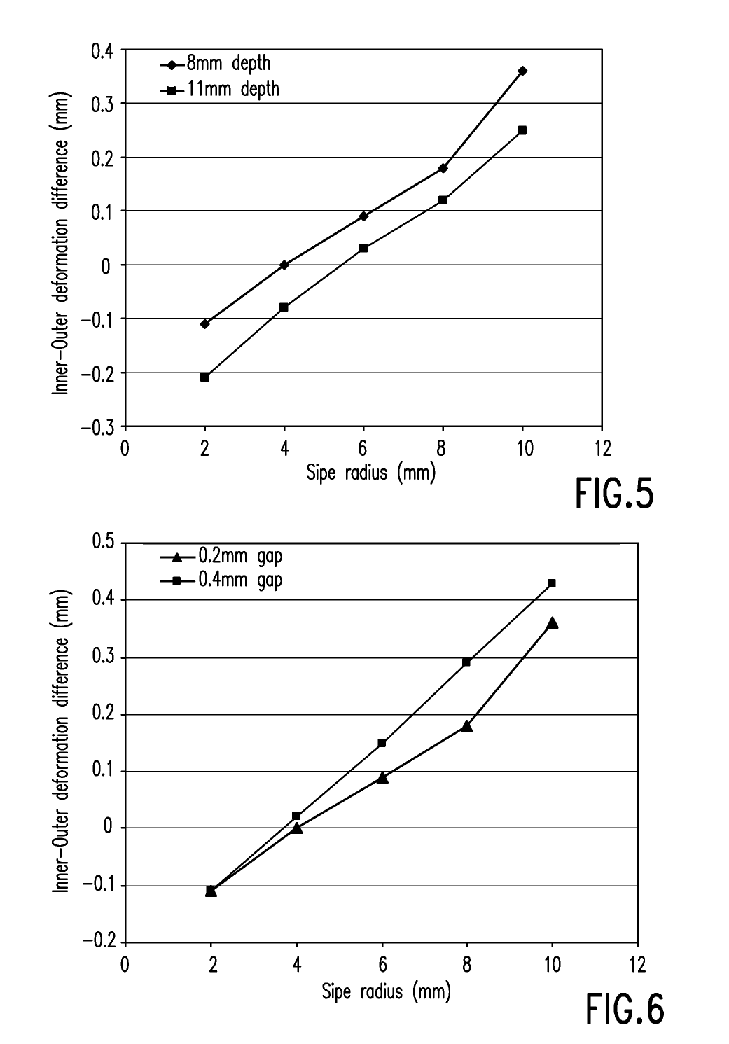

FIG. 6 provides a plot of the simulation results of Table 3, which demonstrates the differences when sipe width 220 is changed. FIG. 6 indicates that for a sipe width 220 of 0.4 mm, sipe radius 215 should not be between 3 mm and 5 mm because the difference in radial deformation is not at least about 0.1 mm. Otherwise, the radius should be greater than 1.5 mm and the distance between the sipe and the tread block outer edge 250 should be greater than 3 mm to avoid off-road tearing degradation. Using the design guidelines previously stated, Table 3 and FIG. 6 show that for this tread block 150, the design of sipe radius 215 should fall into one of the following two ranges:
Range 1: 1.5 mm≦sipe radius 215≦3 mm
Range 2: 5 mm≦sipe radius 215≦9.5 mm

It was also determined that block width 235 and 240 also influences the design of sipe 165 and inner and outer portions 170 and 175. Table 4 presents the results when block widths 235 and 240 are 20 mm, whereas the previous tables were for block widths of 28 mm.

TABLE 4
Displacement of tread block surface with different sipe radius

| | | Inner | Outer | |
|---|---|---|---|---|
| Sipe | Radius | sub-block | sub-block | Inner − Outer |
| Radius | Divided by | displacement | Displacement | Difference |
| (mm) | Block width | (mm) | (mm) | (mm) |
| 8 | 0.4 | −0.58 | −1.06 | 0.48 |
| 6 | 0.3 | −0.62 | −0.92 | 0.30 |
| 4 | 0.2 | −0.67 | −0.83 | 0.17 |
| 2 | 0.1 | −0.72 | −0.77 | 0.05 |

(Block depth = 13 mm, Block width = 20 mm, Sipe gap = 0.4 mm, Sipe depth = 8 mm, Modulus = 5.47 MPa)

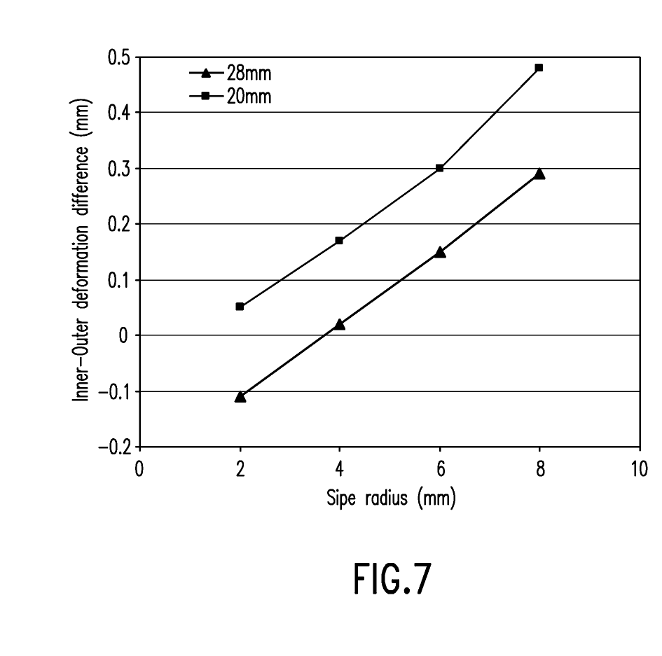

FIG. 7 shows a plot comparing the results for different tread block widths where the tread block 150 is square in shape such that widths 235 and 240 are identical for each simulated width of 20 mm and 28 mm. As shown from the results in Table 4 and FIG. 7, block widths 235 and 240 influence the design of tread block 150. More specifically, for a tread block 150 with dimensions of 20×120×13 mm, the sipe radius 165 should be greater than 3 mm. As stated previously, the distance between the sipe 165 and the block outer edge 245 should be greater than 3 mm. Accordingly, the methods of the present invention reveal that only a stud scenario exists for this kind of tread block such that the range of acceptable radii for radius 215 is
Range 1: 3 mm≦sipe radius 215≦17 mm

Using the teachings disclosed herein, one of skill in the art will understand that other variables can be applied and adjusted using the present invention in order to achieve the desired amount of radial deformation (i.e., at least about 0.1 mm). For example, the materials of construction used for block 150 can be changed in order to select different block material modulii, which in turn will lead to changes in e.g., the sipe radius 165. Additionally, different materials could also be used for the inner and outer portions 170 and 175 in order to obtain the desired difference in radial deformation. Regardless, in each case a tread block 150 can be simulated using e.g., finite element analysis so as to determine the required sipe radii and/or other parameters of block 150 in order to achieve at least 0.1 mm radial deformation difference between inner and outer portions 170 and 175.

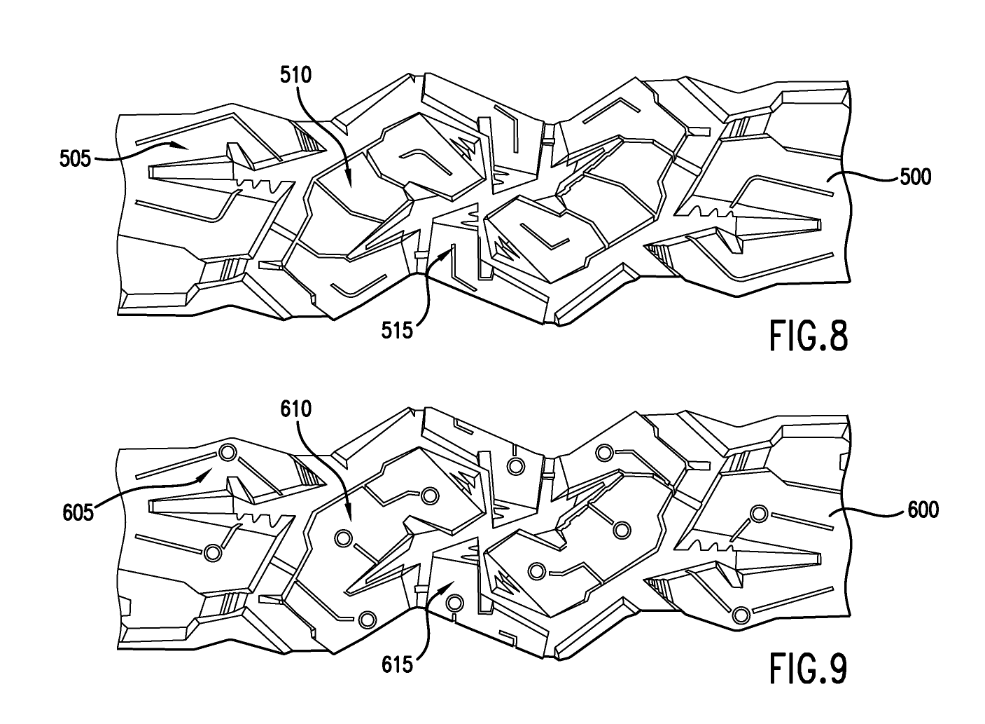

In order to further test and demonstrate the effectiveness of a tread feature constructed as previously described, two tread patterns as shown in FIGS. 8 and 9 were compared. Tread 500 of FIG. 8 contains linear sipes as previously described with regard to FIG. 1B. Tread 600 of FIG. 9 contains tread features 605, 610 and 615 having tubular sipes similar to that previously described with respect to tread block 150. Tread features 605 perform as a cleaner while features 610 and 615 perform as a stud. Note that tread 500 and tread 600 have about the same amount of biting edge with the exception of the tubular sipes which give tread 600 slightly more biting edges. The normalized results of the testing of tires having these tread features is shown in Table 5:

TABLE 5
Results of field tests

| Field Tests | Normal Design (FIG. 9) | Tubular Sipe (FIG. 10) |
|---|---|---|
| Snow Traction | 100 | 104 |
| Off-Road Tearing | 100 | 107 |
| Highway Wear | 100 | 107 |

The tests demonstrate that the tread 600 is improved as compared to tread 500 because it has slightly more biting edges as compared to tread 500 and because of the effects of these sipes acting as a cleaner and stud as previously described. In addition, performances in highway wear and off-road tearing were also improved due to increased block rigidity.

While the present subject matter has been described in detail with respect to specific exemplary embodiments and methods thereof it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for improving the traction and off-road performances of a tire, the tire defining radial and axial directions, the steps comprising:
providing a tread feature having an inner portion, an outer portion and a free edge, wherein the inner portion and outer portion are created by defining an inner sipe that surrounds the inner portion and a connecting sipe that extends to the inner sipe from the free edge of the tread feature, and wherein the inner and outer portions have substantially the same height along the radial direction.

2. The method for improving the traction and off-road performances of a tire as in claim 1, further comprising the following steps:
applying an operating load to the tread feature;
determining the difference in radial deformation along the radial direction of the inner portion relative to the outer portion under the operating load;
modifying the construction of the inner portion, outer portion, or both of the tread feature if the difference in radial deformation between the inner portion and the outer portion is not equal to, or greater than, 0.1 mm; and
repeating one or more of said steps of applying, determining, and modifying until the difference in radial deformation between the inner portion and the outer portion during an operating load is equal to, or greater than, 0.1 mm.

3. The method for improving the traction and off-road performances of a tire as in claim 2, further comprising the steps of operating the tire while repeatedly subjecting the outer portion of the tread feature to a radial deformation that is at least 0.1 mm or greater than the radial deformation of the inner portion of the tread feature.

4. The method for improving the traction and off-road performances of a tire as in claim 2, further comprising the steps of operating the tire while repeatedly subjecting the inner portion of the tread feature to a radial deformation that is at least 0.1 mm or greater than the radial deformation of the outer portion of the tread feature.

5. The method for improving the traction and off-road performances of a tire as in claim 2, wherein the inner sipe has a tubular shape of predetermined radius, and the tubular shape has a length that extends along the radial direction of the tire.

6. The method for improving the traction and off-road performances of a tire as in claim 5, wherein the connecting sipe extends along the axial direction.

7. The method for improving the traction and off-road performances of a tire as in claim 5, wherein the predetermined radius of the inner sipe is greater than or equal to about 1.5 mm.

8. The method for improving the traction and off-road performances of a tire as in claim 1, wherein the inner sipe comprises undulations along the radial direction of the tire.

9. The method for improving the traction and off-road performances of a tire as in claim 1, wherein the distance between any exterior edge of the tread feature and the inner sipe is greater than or equal to about 3 mm.

10. The method for improving the traction and off-road performances of a tire as in claim 2, wherein the tread feature in said providing step is a simulated tread feature, and where said applying step comprises simulating the application of an operating load to the tread feature.

11. The method for improving the traction and off-road performances of a tire as in claim 10, wherein said determining step comprises applying finite element analysis to the simulated tread feature from said providing step.

12. The method for improving the traction and off-road performances of a tire as in claim 1, wherein said inner sipe has a width of about 0.2 mm.

13. The method for improving the traction and off-road performances of a tire as in claim 12, further comprising the step of operating the tire while repeatedly subjecting the outer portion of the tread feature to a radial deformation that is at least 0.1 mm or greater than the radial deformation of the inner portion of the tread feature.

14. The method for improving the traction and off-road performances of a tire as in claim 2, wherein said step of modifying the construction comprises changing the physical dimensions of the inner portion, outer portion, or both of the tread feature.

15. The method for improving the traction and off-road performances of a tire as in claim 2, wherein said step of modifying the construction comprises changing the physical properties of the inner portion, outer portion, or both of the tread feature.

16. The method for improving the traction and off-road performances of a tire as in claim 2, wherein said step of modifying the construction comprises changing the composition of the material used for the inner portion, outer portion, or both of the tread feature.

17. A tire having improved traction and off-road performances, the tire defining axial and radial directions, the tire comprising:
at least one tread feature, said tread feature having an inner portion, an outer portion, and a free edge, wherein said inner and outer portions are created by defining an inner sipe that surrounds the inner portion and a connecting sipe that extends to the inner sipe from the free edge of the tread feature, forming an angle with respect to the free edge of the tread feature, and wherein the inner and outer portions have substantially the same height along the radial direction.

18. The tire having improved traction and off-road performances according to claim 17, wherein said inner portion and outer portions are constructed so that the difference in radial deformation of said inner and outer portions when the tire is subjected to an operating load is greater than, or equal to, about 0.1 mm.

19. The tire having improved traction and off-road performances as in claim 17, wherein said inner sipe comprises a tube defined by the inner and outer portions of said tread feature, said tube having a width of no less than about 0.2 mm, said tube having a predetermined radius of no less than about 1.5 mm.

20. The tire having improved traction and off-road performances as in claim 17, wherein said inner sipe and connecting sipe further comprise undulations along the radial direction of the tire.

21. The tire having improved traction and off-road performances as in claim 17, wherein said connecting sipe undulates in a direction that is substantially perpendicular to the radial direction of the tire.

22. The tire having improved traction and off-road performances as in claim 17, wherein said angle that said connecting sipe forms with the free edge of the tread feature is ninety degrees.
